(19) United States
(12) Patent Application Publication
(10) Pub. No.: US 2026/0320991 A1
(43) Pub. Date: Oct. 15, 2026

(54) DATA PROCESSING METHOD AND APPARATUS, MODEL TRAINING METHOD AND APPARATUS, DEVICE, AND MEDIUM

(71) Applicant: TENCENT TECHNOLOGY (SHENZHEN) COMPANY LIMITED, Shenzhen (CN)

(72) Inventors: Yuying GE, Shenzhen (CN); Yixiao GE, Shenzhen (CN); Sijie ZHAO, Shenzhen (CN); Ying SHAN, Shenzhen (CN); Jinguo ZHU, Shenzhen (CN); Kun YI, Shenzhen (CN); Chen LI, Shenzhen (CN); Lin SONG, Shenzhen (CN)

(21) Appl. No.: 19/694,568

(22) Filed: Jun. 1, 2026

Related U.S. Application Data
(63) Continuation of application No. PCT/CN2025/080393, filed on Mar. 4, 2025.

(30) Foreign Application Priority Data
Apr. 18, 2024 (CN) 202410474106.9

(51) Int. Cl. G06V 10/80; G06V 10/82

(52) U.S. Cl. CPC G06V 10/806; G06V 10/82

(57) ABSTRACT

A data processing method includes obtaining a first image in a target task, and dividing the first image into a plurality of sub-images each having a resolution equal to a target resolution supported by an image encoding and decoding model. The method further includes, for each sub-image, obtaining a location feature of the sub-image in the first image, encoding the sub-image using the image encoding and decoding model to obtain a first image feature of the sub-image, and fusing the first image feature and the location feature to obtain a second image feature of the sub-image. The method also includes processing the second image features of the plurality of sub-images using a task processing model to obtain a third image feature, and decoding the third image feature using the image encoding and decoding model to obtain a second image.

### CROSS-REFERENCE TO RELATED APPLICATIONS

This application is a continuation of International Application No. PCT/CN2025/080393, filed on Mar. 4, 2025, which claims priority to Chinese Patent Application No. 202410474106.9, filed with the China National intellectual Property Administration on Apr. 18, 2024 and entitled “DATA PROCESSING METHOD AND APPARATUS, MODEL TRAINING METHOD AND APPARATUS, DEVICE, AND MEDIUM,” the entire contents of both of which are incorporated herein by reference.

### FIELD OF THE TECHNOLOGY

Embodiments of this application relate to the field of computer technologies, and in particular, to a data processing method and apparatus, a model training method and apparatus, a device, a medium, and a program product.

### BACKGROUND OF THE DISCLOSURE

With the continuous development of artificial intelligence technology, application of artificial intelligence models has become increasingly widespread. Artificial intelligence can be used to implement an interactive task with a user. For example, the user may provide an image and make a requirement for the image, and an artificial intelligence model may process the image based on the requirement of the user.

However, sizes of images in different fields are diversified, making it difficult for the artificial intelligence model to adapt to data processing requirements in different fields. Consequently, adaptability of a data processing method is poor.

### SUMMARY

In accordance with the disclosure, there is provided a data processing method performed by an electronic device and including obtaining a first image in a target task, and dividing the first image into a plurality of sub-images each having a resolution equal to a target resolution supported by an image encoding and decoding model. The method further includes, for each sub-image, obtaining a location feature of the sub-image in the first image, encoding the sub-image using the image encoding and decoding model to obtain a first image feature of the sub-image, and fusing the first image feature and the location feature to obtain a second image feature of the sub-image. The method also includes processing the second image features of the plurality of sub-images using a task processing model to obtain a third image feature, and decoding the third image feature using the image encoding and decoding model to obtain a second image.

Also in accordance with the disclosure, there is provided an electronic device including a processor, and a memory storing at least one computer program that, when executed by the processor, causes the electronic device to obtain a first image in a target task, and divide the first image into a plurality of sub-images each having a resolution equal to a target resolution supported by an image encoding and decoding model. The at least one computer program, when executed by the processor, further causes the electronic device to, for each sub-image, obtain a location feature of the sub-image in the first image, encode the sub-image using the image encoding and decoding model to obtain a first image feature of the sub-image, and fuse the first image feature and the location feature to obtain a second image feature of the sub-image. The at least one computer program, when executed by the processor, also causes the electronic device to process the second image features of the plurality of sub-images using a task processing model to obtain a third image feature, and decode the third image feature using the image encoding and decoding model to obtain a second image.

Also in accordance with the disclosure, there is provided a model training method performed by an electronic device and including obtaining a sample image, processing the sample image based on a target task to obtain a target sample image, obtaining a target sample image feature of the target sample image, and dividing the sample image into a plurality of sample sub-images each having a resolution equal to a target resolution supported by an image encoding and decoding model. The method further includes, for each sample sub-image, obtaining a sample location feature of the sample sub-image in sample image, encoding the sample sub-image using the image encoding and decoding model to obtain a first sample image feature of the sample sub-image, and fusing the first sample image feature and the sample location feature to obtain a second sample image feature of the sample sub-image. The method also includes processing the second sample image features of the plurality of sample sub-images using an initial processing model to obtain a third sample image feature, and training the initial processing model based on the third sample image feature and the target sample image feature to obtain a task processing model configured for processing the target task.

### BRIEF DESCRIPTION OF THE DRAWINGS

To describe the technical solutions in the embodiments of this application more clearly, the following briefly describes the drawings required for describing the embodiments. Apparently, the drawings in the following descriptions show merely some embodiments of this application, and a person of ordinary skill in the art may still derive other drawings from these drawings without creative efforts.

FIG. 1 is a schematic diagram showing an implementation environment according to an embodiment of this application.

FIG. 2 is a flowchart of a data processing method according to an embodiment of this application.

FIG. 3A is a flowchart of another data processing method according to an embodiment of this application.

FIG. 3B is a schematic diagram showing an architecture of a data processing model according to an embodiment of this application.

FIG. 4 is a flowchart of another data processing method according to an embodiment of this application.

FIG. 5 is a schematic diagram showing a multi-modal data sequence according to an embodiment of this application.

FIG. 6 is a schematic diagram showing a data processing method according to an embodiment of this application.

FIG. 7 is a schematic diagram showing an artificial intelligence-based interaction method according to an embodiment of this application.

FIG. 8 is a flowchart of a model training method according to an embodiment of this application.

FIG. 9 is a flowchart of a training method for a task processing model according to an embodiment of this application.

FIG. 10 is a flowchart of another training method for a task processing model according to an embodiment of this application.

FIG. 11 is a flowchart of a training method for an image encoding and decoding model according to an embodiment of this application.

FIG. 12 is a schematic diagram showing a training method for an image encoding and decoding model according to an embodiment of this application.

FIG. 13 is a comparison diagram showing reconstruction results of an image encoding and decoding model according to an embodiment of this application.

FIG. 14 is a flowchart of a pre-training method for an initial processing model according to an embodiment of this application.

FIG. 15 is a comparison diagram showing data processing results according to an embodiment of this application.

FIG. 16 is a schematic diagram showing a structure of a data processing apparatus according to an embodiment of this application.

FIG. 17 is a schematic diagram showing a structure a model training apparatus according to an embodiment of this application.

FIG. 18 is a schematic diagram showing a structure of another model training apparatus according to an embodiment of this application.

FIG. 19 is a schematic diagram showing a structure of a terminal according to an embodiment of this application.

FIG. 20 is a schematic diagram showing a structure of a server according to an embodiment of this application.

### DESCRIPTION OF EMBODIMENTS

To make objectives, technical solutions, and advantages of embodiments of this application clearer, the following further describes implementations of this application in detail with reference to the drawings.

The terms “first,” “second,” or the like used in this application may be used for describing various concepts in this specification. However, the concepts are not limited by the terms unless otherwise specified. The terms are used only to distinguish a concept from another concept. For example, without departing from the scope of this application, a first image may be referred to as a second image, and similarly, a second image may be referred to as a first image.

“At least one” means one or more. For example, at least one image may be any integer quantity of images greater than or equal to one, such as one image, two images, or three images. “A plurality of” means two or more. For example, a plurality of images may be any integer quantity of images greater than or equal to two, such as two images or three images. “Each” means each of at least one. For example, each image is each of a plurality of images, and if the plurality of images are three images, each image is each of the three images.

Information (including but not limited to user device information, user personal information, or the like), data (including but not limited to data for analysis, stored data, presented data, or the like), and signals (including but not limited to a signal transmitted between a user terminal and another device, or the like) in this application are all authorized by a user or fully authorized by a related party, and collection, use, and processing of relevant data need to comply with relevant laws, regulations, and standards of relevant countries and regions.

A data processing method and a model training method provided in the embodiments of this application can be performed by an electronic device. In some embodiments, the electronic device may be a computer device, for example, a terminal or a server. In some embodiments, the server is an independent physical server, a server cluster or a distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. In some embodiments, the terminal is but is not limited to a smartphone, a tablet computer, a notebook computer, a desktop computer, a smart speaker, a smartwatch, a smart voice interaction device, a smart household appliance, an in-vehicle terminal, or the like.

In some embodiments, a computer program in the embodiments of this application may be deployed on one electronic device for execution, executed on a plurality of electronic devices at one location, or executed on a plurality of electronic devices distributed at a plurality of locations and connected to each other through a communication network. The plurality of electronic devices distributed at the plurality of locations and connected to each other through the communication network may form a blockchain system.

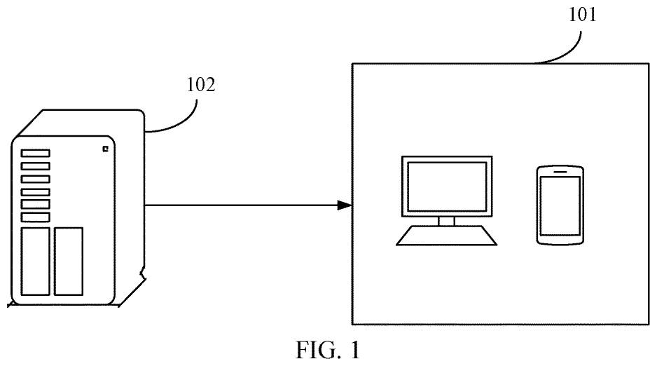

In some embodiments, FIG. 1 is a schematic diagram showing an implementation environment according to an embodiment of this application. Referring to FIG. 1, the implementation environment includes a terminal 101 and a server 102. The terminal 101 and the server 102 are connected to each other through a wired or wireless network.

The server 102 trains an image encoding and decoding model and a task processing model by using the model training method provided in the embodiments of this application, and stores a trained image encoding and decoding model and a trained task processing model. The image encoding and decoding model is configured for encoding and decoding an image. The task processing model is configured for generating a feature related to a target task.

In some embodiments, the terminal 101 transmits a target task carrying a first image to the server 102. The server 102 receives the target task, encodes the first image by using the image encoding and decoding model, to obtain an image feature, processes the image feature by using the task processing model, to obtain a processed image feature, and then decodes the processed image feature by using the image encoding and decoding model, to obtain a second image. The second image is a result of processing the first image based on the target task. The server 102 returns the second image to the terminal 101. The terminal 101 presents the second image to a user.

In some other embodiments, the server 102 transmits the image encoding and decoding model and the task processing model to the terminal 101. The terminal 101 encodes, for a target task carrying a first image, the first image by using the image encoding and decoding model, to obtain an image feature, processes the image feature by using the task processing model, to obtain a processed image feature, and then decodes the processed image feature by using the image encoding and decoding model, to obtain a second image.

In some embodiments, a target application served by the server 102 is installed on the terminal 101. The server 102 delivers the image encoding and decoding model and the task processing model to the target application. The terminal 101 may process, in the target application by using the image encoding and decoding model and the task processing model, an image and data that need to be processed in the target task, to obtain a processing result.

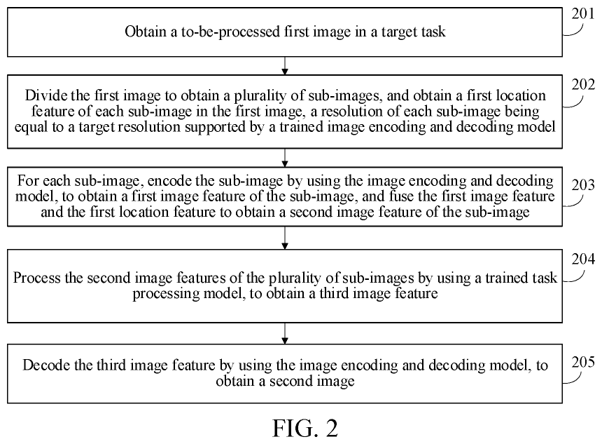

FIG. 2 is a flowchart of a data processing method according to an embodiment of this application. This embodiment of this application is executed by an electronic device. The electronic device may be the terminal 101 or the server 102 in FIG. 1. Referring to FIG. 2, the method includes the following operations.

201: Obtain a to-be-processed first image in a target task.

The first image is an image that needs to be processed in the target task. The target task includes a task of processing the first image.

In this embodiment of this application, the target task may be any type of task, for example, an image editing task or a slide generation task. For example, the target task is the image editing task. The target task may include recognizing content in the first image, removing an object in the first image, matting the first image, or the like. Specific content of the target task is not limited in the embodiments of this application.

202: Divide the first image to obtain a plurality of sub-images, and obtain a first location feature of each sub-image in the first image, a resolution of each sub-image being equal to a target resolution supported by a trained image encoding and decoding model.

The electronic device divides the first image based on the target resolution corresponding to the image encoding and decoding model, to obtain the plurality of sub-images, the resolution of each sub-image being equal to the target resolution.

In this embodiment of this application, a resolution of the first image may be any resolution, and the image encoding and decoding model corresponds to the target resolution. The target resolution is a resolution supported by the image encoding and decoding model. In other words, the image encoding and decoding model can process only an image whose resolution is equal to the target resolution.

When the resolution of the first image is greater than the target resolution, the image encoding and decoding model cannot directly process the first image. In this case, the electronic device divides the first image, i.e., segments the first image, based on the target resolution to obtain the plurality of sub-images, so that the resolution of each sub-image is equal to the target resolution. Subsequently, the image encoding and decoding model may perform encoding and decoding by using the sub-image as a unit. Therefore, even if the resolution of the first image does not match the target resolution corresponding to the image encoding and decoding model, the first image can be processed.

Because the sub-image is obtained by dividing the first image, although a first image feature of the sub-image includes content of the sub-image in the first image, the first image feature does not include location information of the sub-image in the first image. Therefore, to retain the location information of each sub-image in the first image, the electronic device further obtains the first location feature of each sub-image. The first location feature indicates a location of the sub-image in the first image.

203: For each sub-image, encode the sub-image by using the image encoding and decoding model, to obtain a first image feature of the sub-image, and fuse the first image feature and the first location feature to obtain a second image feature of the sub-image.

In this embodiment of this application, the image encoding and decoding model is configured for encoding and decoding an image. In some embodiments, the image encoding and decoding model includes an image encoding network and an image decoding network, where the image encoding network is configured for encoding the image to obtain an image feature, and the image decoding network is configured for decoding the image feature to obtain an image.

After the electronic device obtains the plurality of sub-images through segmentation, for any sub-image, the electronic device inputs the sub-image into the image encoding network of the image encoding and decoding model, and the image encoding network encodes the sub-image to output the first image feature of the sub-image.

Further, for each sub-image, the electronic device fuses the first image feature of the sub-image and the first location feature of the sub-image to obtain the second image feature of the sub-image. The second image feature not only includes content of the sub-image in the first image, but also includes the location information of the sub-image in the first image. Therefore, the second image features of the plurality of sub-images can fully represent the features of the entire first image, thereby voiding loss of location information caused by image division.

204: Process the second image features of the plurality of sub-images by using a trained task processing model, to obtain a third image feature.

The task processing model is configured for generating a feature related to the target task. For example, if the target task includes deblurring an image, the task processing model can generate a deblurred image feature. For another example, if the target task includes performing style transfer on an image, the task processing model can generate an image feature obtained through style transfer.

After obtaining the second image feature of each sub-image, the electronic device inputs the second image features of the plurality of sub-images into the task processing model. The task processing model processes the second image features of the plurality of sub-images, for example, performs deep feature extraction, feature crossing, and feature mapping. The task processing model outputs the third image feature. The third image feature is a feature of a second image that needs to be generated in the target task.

205: Decode the third image feature by using the image encoding and decoding model, to obtain the second image.

After obtaining the third image feature, the electronic device inputs the third image feature into the image decoding network of the image encoding and decoding model, and the image decoding network outputs the second image obtained through decoding. The second image is a processing result required by the target task, that is, an image obtained by processing the first image based on the target task.

According to the method provided in this embodiment of this application, when an image that needs to be processed in the target task does not match the target resolution corresponding to the image encoding and decoding model, the image is divided into a plurality of sub-images whose resolutions are equal to the target resolution, so that the sub-images are directly encoded by using the image encoding and decoding model. In addition, location features of the sub-images are further fused with image features of the sub-images, to retain location information of each sub-image in the complete image. Further, the image feature of each sub-image is processed by using the task processing model, and the processed image feature is decoded, to obtain a second image, that is, the processing result of the target task. In this way, the image is divided and the location information is retained, so that the image encoding and decoding model is applicable to an image of any resolution, improving adaptability of the data processing method.

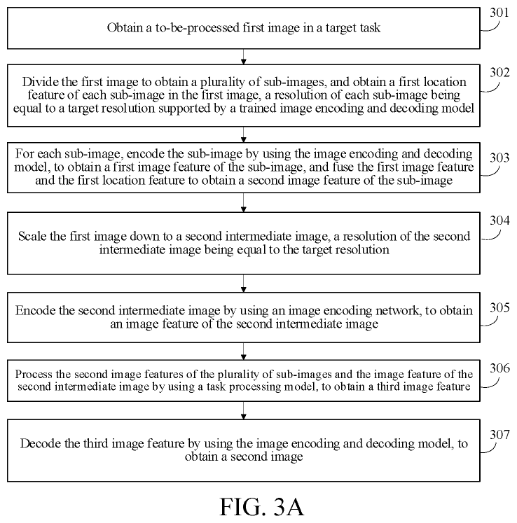

Based on the foregoing embodiment, when the resolution of the first image is greater than the target resolution, in addition to encoding the plurality of sub-images obtained by dividing the first image, the electronic device may further scale the first image to the target resolution for encoding. For a detailed process, refer to the following embodiment shown in FIG. 3A.

FIG. 3A is a flowchart of another data processing method according to an embodiment of this application. This embodiment of this application is executed by an electronic device. The electronic device may be the terminal 101 or the server 102 in FIG. 1. Referring to FIG. 3A, the method includes the following operations.

301: Obtain a to-be-processed first image in a target task.

In some embodiments, the electronic device receives a processing request for the target task. The processing request for the target task carries the first image. The processing request for the target task is configured for indicating to process the first image based on the target task. In this embodiment of this application, the first image may be an image of any resolution.

302: Divide the first image to obtain a plurality of sub-images, and obtain a first location feature of each sub-image in the first image, a resolution of each sub-image being equal to a target resolution supported by a trained image encoding and decoding model.

The image encoding and decoding model can process only an image whose resolution is equal to the target resolution. When the resolution of the first image is greater than the target resolution, the image encoding and decoding model cannot directly process the first image. Therefore, before the first image is scaled, operation 302 is first performed to divide the first image into the sub-images whose resolutions are equal to the target resolution. In this way, an image of any size and aspect ratio can be processed in the method described in this embodiment of this application.

In some embodiments, the electronic device determines a plurality of division policies, each of the division policies including a first division quantity, a second division quantity, and a division ratio; determines a target division policy from the plurality of division policies based on an aspect ratio of the first image, a division ratio in the target division policy being closest to the aspect ratio; and divides the first image based on the target division policy and the target resolution, to obtain the plurality of sub-images.

The first division quantity is a division quantity of an image in a length direction. The second division quantity is a division quantity of the image in a width direction. The division ratio is a ratio of the first division quantity to the second division quantity. For example, the plurality of division policies include a division policy 1, a division policy 2, and a division policy 3. A division ratio in the division policy 1 is 5:1, a division ratio in the division policy 2 is 4:3, and a division ratio in the division policy 3 is 16:9. If the aspect ratio of the first image is 16:9, the division ratio in the division policy 3 is the closest to the aspect ratio of the first image. Therefore, the division policy 3 is determined as the target division policy.

After the target division policy is determined, the first image may be divided based on the first division quantity and the second division quantity in the target division policy, and the target resolution, to obtain the plurality of sub-images.

In this embodiment of this application, the plurality of division policies for selection are provided, a division policy best adapted to the aspect ratio of the first image is selected as the target division policy based on the division ratios in the division policies, and division is performed according to the target division policy. Providing the division policy in advance helps to improve image division efficiency.

In some embodiments, that the electronic device divides the first image based on the target division policy and the target resolution, to obtain the plurality of sub-images includes: generating a target size based on the target division policy and the target resolution; upsampling the first image based on the target size, to obtain a first intermediate image; and dividing the first intermediate image according to the target division policy, to obtain the plurality of sub-images.

For example, a first division quantity in the target division policy is Nh, a second division quantity in the target division policy is Nw, the target resolution is Ht×Wt, the target size includes a length and a width, the length of the target size is equal to Nh*Ht, and the width of the target size is equal to Nw*Wt. The first image is upsampled to obtain the first intermediate image, so that a length of the first intermediate image is equal to the length Nh*Ht of the target size, and a width is equal to the width Nw*Wt of the target size. Further, the first intermediate image is divided according to the target division policy, that is, the first intermediate image is divided into Nh parts in the length direction and Nw parts in the width direction, to obtain the plurality of sub-images.

In this embodiment of this application, the target size is first generated based on the target division policy and the target resolution, where the target size is a size required for obtaining the sub-images of the target resolution through division according to the target division policy. Then, the first image is upsampled to obtain the first intermediate image of the target size. This can ensure that the resolution of each sub-image obtained through division is equal to the target resolution.

303: For each sub-image, encode the sub-image by using the image encoding and decoding model, to obtain a first image feature of the sub-image, and fuse the first image feature and the first location feature to obtain a second image feature of the sub-image.

In some embodiments, the image encoding and decoding model includes an image encoding network and an image decoding network. The image encoding network may be a variable autoencoder (VAE), a visual tokenizer (ViT), or the like. A type of the image encoding network is not limited in the embodiments of this application.

For any sub-image, the electronic device inputs the sub-image into the image encoding network of the image encoding and decoding model, and the image encoding network encodes the sub-image to output the first image feature of the sub-image. The first image feature is an image feature of the sub-image.

Further, the first location feature of each sub-image is added to the respective first image feature, to obtain the second image feature of each sub-image, so that a second image not only includes content of the sub-image, but also includes location information of the sub-image in the complete first image.

In some embodiments, that the electronic device obtains a first location feature of each sub-image in the first image includes: for any sub-image, mapping coordinate information of the sub-image in the first image; and mapping the coordinate information based on a mapping parameter, to obtain the first location feature of the sub-image, the mapping parameter being obtained through training. Specific mapping is an operation of multiplying the mapping parameter by the coordinate information.

In some embodiments, the mapping parameter includes a left-side mapping parameter, a right-side mapping parameter, an upper-side mapping parameter, and a lower-side mapping parameter. The coordinate information includes a normalized horizontal coordinate and a normalized vertical coordinate. The electronic device may determine the first location feature by using the following formula:

p=x_c·l+(1−x_c)·r+y_c·t+(1−y_c)·b

Herein, p represents the first location feature, x_c represents the horizontal coordinate, y_c represents the vertical coordinate, l represents the left-side mapping parameter, r represents the right-side mapping parameter, t represents the upper-side mapping parameter, and b represents the lower-side mapping parameter. In some embodiments, the foregoing mapping parameters are all vectors.

In some embodiments, the sub-image includes a plurality of image blocks. The image block is a smallest unit in the image. For example, the image block can include, e.g., one or more pixels. The first location feature of the sub-image includes a location feature of each image block in the sub-image. For each image block in a sub-image, the electronic device determines coordinate information of the image block in the first image, and maps the coordinate information of the image block based on the mapping parameter, to obtain the location feature of the image block. The first image feature of the sub-image includes an image feature of each image block. For each image block in the sub-image, the electronic device fuses the image feature and the location feature of the image block to obtain a fused image feature of the image block. Then, for the sub-image, the electronic device fuses the fused image features of the plurality of image blocks in the sub-image, to obtain the second image feature of the sub-image.

In some embodiments, the coordinate information of the sub-image in the first image is coordinate information of a central point of the sub-image in the first image.

304: Scale the first image down to a second intermediate image, a resolution of the second intermediate image being equal to the target resolution.

In this embodiment of this application, in addition to encoding the sub-image, the first image may further be scaled down to the second intermediate image of the target resolution, and then the second intermediate image is encoded. This helps to retain global visual context information of the first image, and helps to improve accuracy of subsequent image feature-based processing.

305: Encode the second intermediate image by using the image encoding network, to obtain an image feature of the second intermediate image.

Because the resolution of the second intermediate image is equal to the target resolution, the image encoding network can process the second intermediate image.

The electronic device inputs the second intermediate image into the image encoding network, and the image encoding network encodes the second intermediate image to output the image feature of the second intermediate image.

306: Process the second image features of the plurality of sub-images and the image feature of the second intermediate image by using a task processing model, to obtain a third image feature.

After obtaining the second image feature of each sub-image and the image feature of the second intermediate image, the electronic device inputs the second image features of the plurality of sub-images and the image feature of the second intermediate image into the task processing model. The task processing model processes the second image features of the plurality of sub-images and the image feature of the second intermediate image, for example, performs deep feature extraction, feature crossing, and feature mapping. The task processing model outputs the third image feature.

In some embodiments, the task processing model is a large language model (LLM), a multi-modal model, or the like. A type of the task processing model is not limited in the embodiments of this application.

307: Decode the third image feature by using the image encoding and decoding model, to obtain the second image.

In some embodiments, the image encoding and decoding model includes the image decoding network. That the electronic device decodes the third image feature by using the image encoding and decoding model, to obtain the second image includes: performing feature conversion on the first image by using the image decoding network, to obtain a query feature; performing feature conversion on the third image feature by using the image decoding network, to obtain a key feature and a value feature; fusing the query feature, the key feature, and the value feature to obtain a fused feature; and decoding the fused feature by using the image decoding network, to obtain the second image.

In some embodiments, the image decoding network includes at least one cross-attention layer. For example, the image decoding network includes four cross-attention layers. The electronic device inputs the first image and a noise vector into the image decoding network. The image decoding network performs feature conversion on the first image and the noise vector, and uses a feature obtained through feature conversion as the query feature in an attention mechanism. The electronic device inputs the third image feature into the image decoding network. The image decoding network performs feature conversion on the third image feature, and uses features obtained through feature conversion as the key feature and the value feature in the attention mechanism. In some embodiments, the image decoding network includes a conversion matrix. The conversion matrix is configured for performing the foregoing feature conversion, that is, separately converting the input features to obtain the query feature, the key feature, and the value feature in the attention mechanism.

In this embodiment of this application, when the third image feature is decoded, the first image is introduced as a reference in operations 304 to 306, so that fine-grained information in the first image can be learned in a process of decoding the third image feature into the second image, to avoid loss of original content in the first image, helping to improve quality and an effect of the generated second image, and implementing fine-grained image generation.

In addition, if a reference image is introduced, that is, the method in FIG. 3A is used, the image encoding and decoding model can obtain a fine-grained image through decoding; or if no reference image is introduced, that is, the method in FIG. 2 is used, the image encoding and decoding model can obtain a coarse-grained image through decoding. This improves flexibility, and implements multi-granularity image generation.

In some embodiments, the third image feature may be uniformly pooled, and the image decoding network decodes the pooled third image feature to obtain the second image.

This embodiment of this application is described by using an example in which the image encoding and decoding model and the task processing model are two different models. In another embodiment, the image encoding and decoding model and the task processing model may alternatively be considered as different parts of an overall model. In some embodiments, the overall model is referred to as a data processing model. As shown in FIG. 3B, a data processing model 310 includes an image encoding network 311, a task processing model 312, and an image decoding network 313. The image encoding network 311 and the image decoding network 313 form an image encoding and decoding model. The image encoding network 311 and the image decoding network 313 are separately connected to the task processing model 312.

Specifically, the method shown in FIG. 2 is used as an example. The plurality of sub-images of the first image are input into the image encoding network 311, to output the first image features. Subsequently, the first image features are fused with the first location features to obtain the second image features as an input to the task processing model 312. Then, the third image feature is outputted by using the task processing model 312, and then is inputted into the image decoding network 313, to finally output the second image.

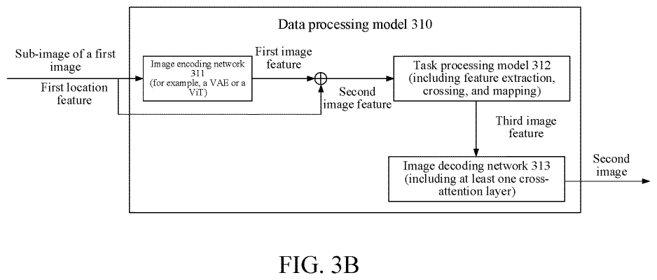

Based on the foregoing embodiment, the target task may alternatively be a multi-modal task. In addition to an image, to-be-processed data in the target task further includes non-image data. For a detailed process of the data processing method, refer to the following embodiment shown in FIG. 4. FIG. 4 is a flowchart of another data processing method according to an embodiment of this application. This embodiment of this application is executed by an electronic device. The electronic device may be the terminal 101 or the server 102 in FIG. 1. Referring to FIG. 4, the method includes the following operations.

401: Obtain a first image and first non-image data, both the first image and the first non-image data being to-be-processed data (also referred to as “target data”) in a target task.

The target task is a multi-modal task. The multi-modal task is a task for processing a plurality of types of data. The first non-image data is other data except an image. For example, the first non-image data may be a text, a video, or audio. This is not limited in the embodiments of this application.

For example, if the target task is a multi-modal task combining an image and a text, the first non-image data is a first text. In this case, the first image and the first text may be an image description pair, structured image-text data, interleaved image-text data, optical character recognition (OCR) data, or the like. The image description pair includes an image and a text for describing content of the image. The structured image-text data includes an image and a text for performing structured description on the image. The interleaved image-text data means that an image and a text are interspersed. The OCR data includes an image and a text obtained by recognizing a character in the image.

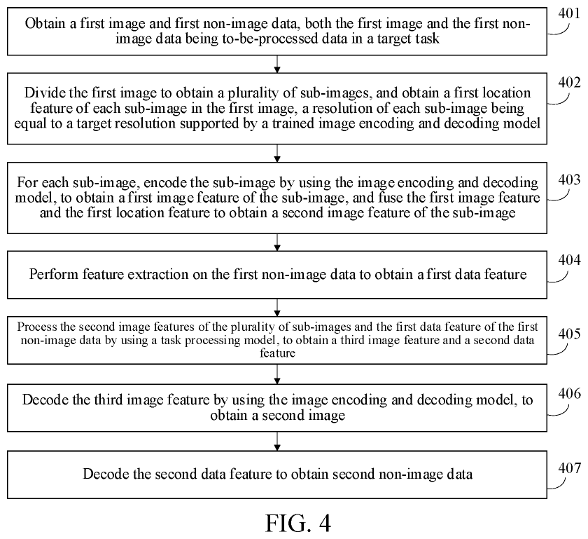

FIG. 5 is a schematic diagram showing a multi-modal data sequence according to an embodiment of this application. As shown in FIG. 5, to-be-processed data in the multi-modal task is a multi-modal data sequence, and the multi-modal data sequence includes at least one image and at least one text. For example, the multi-modal data sequence includes an image 501, a text 502, and an image 503.

402: Divide the first image to obtain a plurality of sub-images, and obtain a first location feature of each sub-image in the first image, a resolution of each sub-image being equal to a target resolution supported by a trained image encoding and decoding model.

403: For each sub-image, encode the sub-image by using the image encoding and decoding model, to obtain a first image feature of the sub-image, and fuse the first image feature and the first location feature to obtain a second image feature of the sub-image.

Processes of operation 402 and operation 403 are the same as the processes of operation 302 and operation 303. Details are not described herein again.

404: Perform feature extraction on the first non-image data to obtain a first data feature.

In some embodiments, the electronic device performs feature extraction on the first non-image data by using a non-image encoding and decoding model, to obtain the first data feature. The non-image encoding and decoding model is configured for processing non-image data. For example, if the first non-image data is a text, the non-image encoding and decoding model is a text encoding and decoding model. If the first non-image data is audio, the non-image encoding and decoding model is an audio encoding and decoding model. In some embodiments, the non-image encoding and decoding model includes a non-image encoding network and a non-image decoding network, and the electronic device performs feature extraction on the first non-image data by using the non-image encoding network, to obtain the first data feature.

In some embodiments, the first non-image data is the first text, the first data feature is a text feature, and the text feature may be an embedding vector or the like. In some embodiments, the electronic device queries a dictionary to map each word in the first text to an embedding vector corresponding to the word. The dictionary includes correspondences between a plurality of words and embedding vectors of the words.

405: Process the second image features of the plurality of sub-images and the first data feature of the first non-image data by using a task processing model, to obtain a third image feature and a second data feature.

After obtaining the second image feature of each sub-image and the first data feature of the first non-image data, the electronic device inputs the second image features of the plurality of sub-images and the first data feature into the task processing model. The task processing model processes the inputted features, for example, performs deep feature extraction, feature crossing, and feature mapping, and outputs the third image feature and the second data feature. The third image feature is a feature of a second image that needs to be generated in the target task, and the second data feature is a feature of non-image data that needs to be generated in the target task.

In some embodiments, the first non-image data is a text, and the text includes coordinate information of an object in the first image. The electronic device converts the coordinate information into a second location feature, fuses the first data feature and the second location feature to obtain a third data feature; and processes the second image features of the plurality of sub-images and the third data feature by using the task processing model, to obtain the third image feature and the second data feature.

In this embodiment of this application, to improve a processing effect, when the text includes the coordinate information of the object in the first image, the coordinate information is converted into the second location feature. The second location feature can represent a location of the object in the image. In some embodiments, the electronic device obtains a plurality of preset candidate location markers, each candidate location marker indicating a different location in the image. The electronic device determines a target location marker in the plurality of candidate location markers based on the coordinate information, a location indicated by the target location marker in the image being the same as a location indicated by the coordinate information in the image. The electronic device uses the target location marker as the second location feature, and adds the second location feature to the first data feature.

In some embodiments, before inputting the second image features of the plurality of sub-images and the first data feature of the first non-image data into the task processing model, the electronic device adds an image start marker in front of the second image features of the plurality of sub-images, and adds an image end marker behind the second image features of the plurality of sub-images, to indicate a start and an end of the image feature, for distinguishing between the image feature and the data feature. For example, the image start marker is “IMG,” and the image end marker is “/IMG.”

406: Decode the third image feature by using the image encoding and decoding model, to obtain the second image.

A process of operation 406 is similar to the process of operation 307. Details are not described herein again.

407: Decode the second data feature to obtain second non-image data.

In some embodiments, the electronic device decodes the second data feature by using a non-image encoding and decoding model, to obtain the second non-image data. The non-image encoding and decoding model is configured for processing non-image data. In some embodiments, the non-image encoding and decoding model includes a non-image encoding network and a non-image decoding network, and the electronic device decodes the second data feature by using the non-image decoding network, to obtain the second non-image data.

In some embodiments, the first non-image data is the first text, the second non-image data is a second text, the second data feature is a text feature, and the text feature may be an embedding vector or the like. In some embodiments, the electronic device queries a dictionary to map the text feature to a word corresponding to the text feature, to obtain the second text. The dictionary includes correspondences between a plurality of words and embedding vectors of the words.

Based on the foregoing embodiment, the task processing model can process a feature of multi-modal data, improving a processing capability of the task processing model. In addition, the task processing model can be applicable to a plurality of types of data in various scenarios, further improving adaptability of the data processing method.

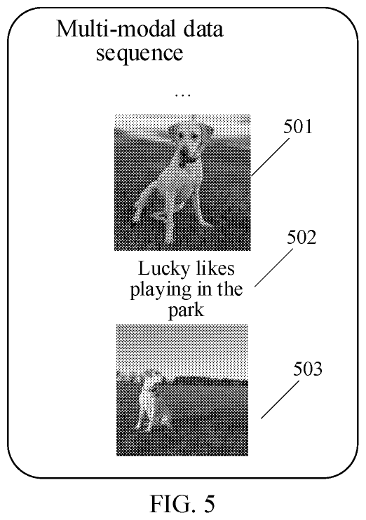

FIG. 6 is a schematic diagram showing a data processing method according to an embodiment of this application. As shown in FIG. 6, to-be-processed data in a target task includes a first image and a first text. The first image is divided and scaled to obtain an image sequence 601. The image sequence 601 includes sub-images 6012 to 6015 obtained through division and a second intermediate image 6011 obtained through scaling down. The first text is “Lucky likes playing in the park.” The images 6011 to 6015 in the image sequence 601 are encoded by using an image encoding network (not shown) of an image encoding and decoding model, to obtain an image feature 602. The first text is encoded to obtain a text feature 603. An electronic device further randomly generates an image feature 604, adds an image start marker “IMG” in front of each of the image feature 602 and the image feature 604, adds an image end marker “/IMG” behind each of the image feature 602 and the image feature 604, and adds a start marker “BOI” in front of the inputted features that are considered as a whole.

As shown in FIG. 6, the electronic device inputs the foregoing features and markers into a task processing model, and the task processing model outputs a predicted image feature 605 and a predicted text feature 606. The electronic device inputs the image feature 605 to an image decoding network of the image encoding and decoding model, and the image decoding network outputs a second image 607. The electronic device may further decode the text feature 606 to obtain a second text. The second image 607 and the second text are processing results obtained by processing the first image and the first text based on the target task.

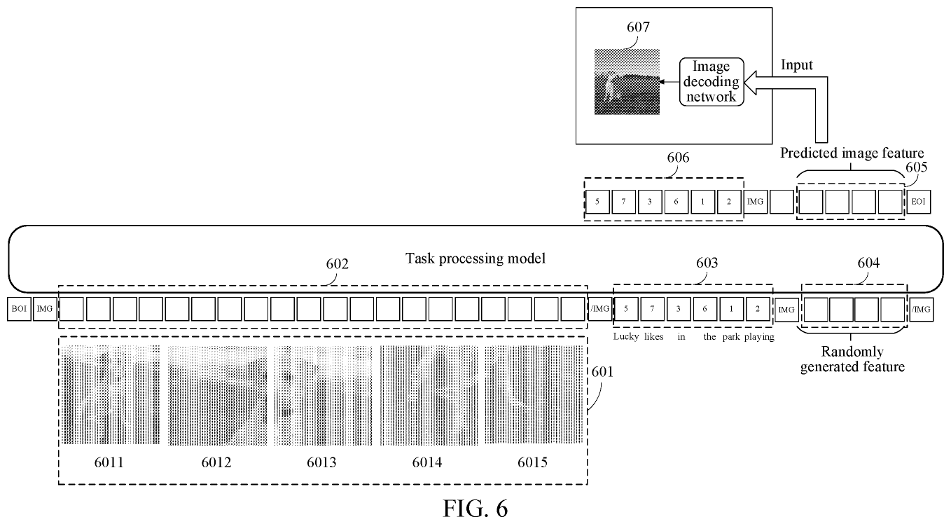

FIG. 7 is a schematic diagram showing an artificial intelligence-based interaction method according to an embodiment of this application. A function of an AI assistant can be implemented by using the image encoding and decoding model and the task processing model, so that a user can interact with the AI assistant. As shown in FIG. 7, in a target task 701, the user inputs an image 711 and a text “Show me a photo of the room after decoration,” and the AI assistant outputs an image 721 and a text “Here's the photo for you.” In a target task 702, the user inputs an image 712 and a text “Can you draw a colorful animation character based on the sketch,” and the AI assistant outputs an image 722 and a text “This is an animation character I created for you.” In a target task 703, the user inputs an image 713 and a text “Can you create an illustration for this novel,” and the AI assistant outputs an image 723 and a text “Sure, enjoy the illustration.” In a target task 704, the user inputs an image 714 and a text “Can you turn this photo into a watercolor painting,” and the AI assistant outputs an image 724 and a text “Sure.”

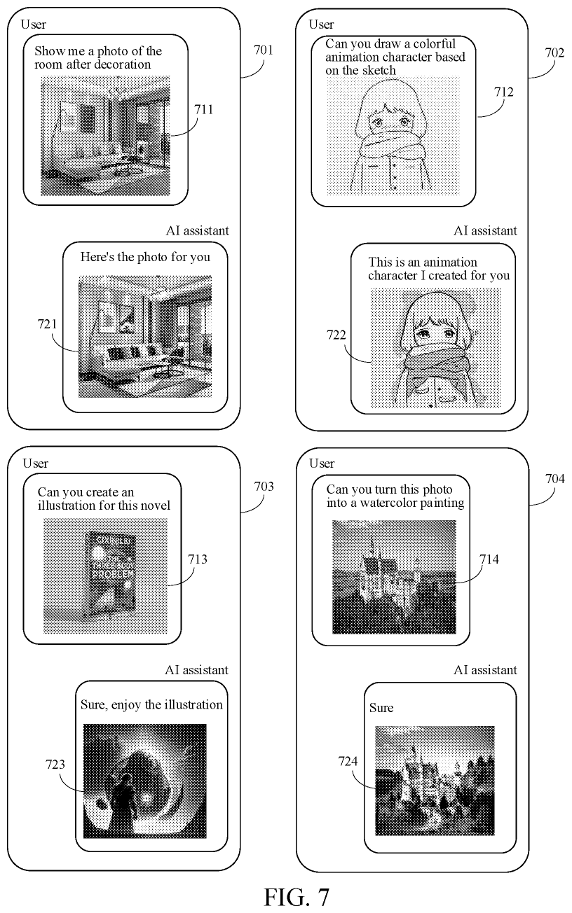

For a training process of the task processing model used in the foregoing embodiment, refer to the following embodiment shown in FIG. 8. FIG. 8 is a flowchart of a model training method according to an embodiment of this application. This embodiment of this application is executed by an electronic device. The electronic device may be the terminal 101 or the server 102 in FIG. 1. Referring to FIG. 8, the method includes the following operations.

801: Obtain a first sample image.

The first sample image is a sample image that needs to be processed in a target task. A process of operation 801 is similar to the process of operation 301. Details are not described herein again.

802: Process the first sample image based on the target task, to obtain a target sample image, and obtain a target sample image feature of the target sample image.

The target sample image is a result of processing the first sample image based on the target task. For example, if the target task is transferring a style of the first sample image to an animation style, the target sample image is an image obtained by transferring the style of the first sample image to the animation style. For example, if the target task is removing an object from the first sample image, the target sample image is an image obtained by removing the object from the first sample image.

In some embodiments, that the electronic device obtains a target sample image feature of the target sample image includes:
dividing the target sample image to obtain a plurality of target sub-images, and obtaining a second sample location feature of each target sub-image in the target sample image, a resolution of each target sub-image being equal to a target resolution; and
for each target sub-image,
encoding the target sub-image by using an image encoding and decoding model, to obtain an image feature of the target sub-image; and
fusing the image feature and the second sample location feature of the target sub-image to obtain the target sample image feature of the target sub-image.

A process in which the electronic device obtains the target sample image feature of each target sub-image in the target sample image is the same as the process of obtaining the second image feature of each sub-image in the first image in the foregoing embodiment. Details are not described herein again.

803: Divide the first sample image to obtain a plurality of first sample sub-images, and obtain a first sample location feature of each first sample sub-image in the first sample image, a resolution of each first sample sub-image being equal to the target resolution supported by the trained image encoding and decoding model.

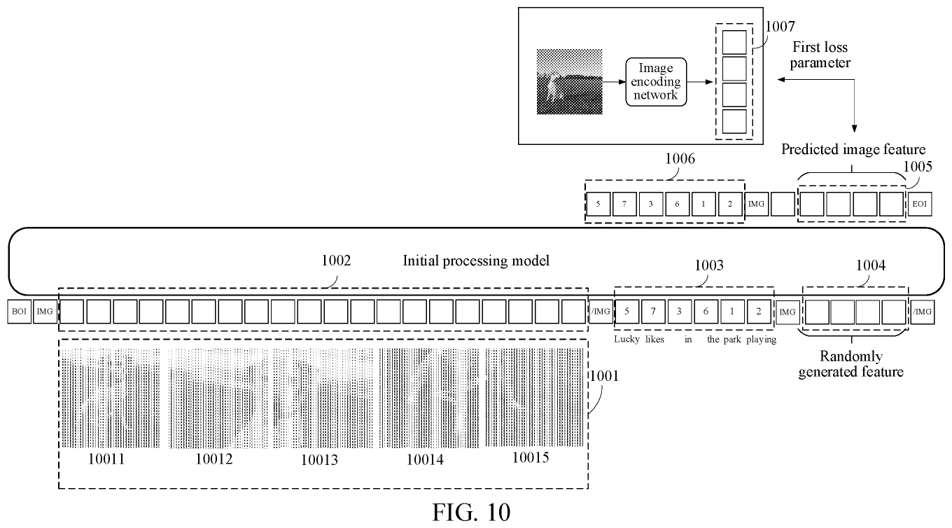

In some embodiments, a training process for the image encoding and decoding model is decoupled from a training process for a task processing model. The embodiment shown in FIG. 8 is the training process for the task processing model. In this embodiment, the image encoding and decoding model is a trained model. For the training process for the image encoding and decoding model, refer to the following embodiment shown in FIG. 11. Details are not described herein again.

804: For each first sample sub-image, encode the first sample sub-image by using the image encoding and decoding model, to obtain a first sample image feature of the first sample sub-image, and fuse the first sample image feature and the first sample location feature to obtain a second sample image feature of the first sample sub-image.

Processes of operation 803 and operation 804 are similar to the processes of operation 302 and operation 303. Details are not described herein again.

805: Process the second sample image features of the plurality of first sample sub-images by using an initial processing model, to obtain a third sample image feature.

The initial processing model is configured for processing a feature, for example, performing deep feature extraction, feature crossing, and feature mapping.

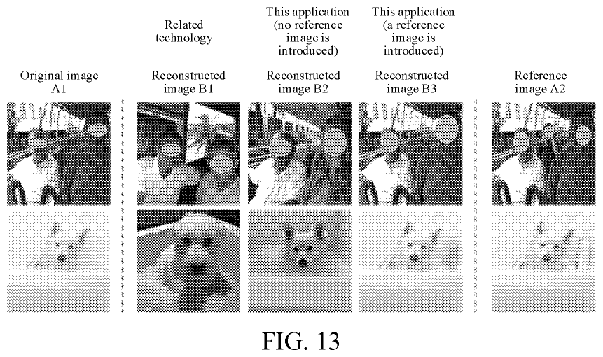

In some embodiments, the initial processing model is a pre-trained model. For a pre-training process for the initial processing model, refer to the following embodiment shown in FIG. 14. Details are not described herein again.

806: Train the initial processing model based on the third sample image feature and the target sample image feature, to obtain the task processing model configured for processing the target task.

In this embodiment of this application, the target sample image feature is a result obtained by processing the first sample image based on the target task, and a target of the initial processing model is to obtain the target sample image feature. In other words, a higher similarity between the third sample image feature generated by the initial processing model and the target sample image feature indicates higher accuracy in the training process for the initial processing model. Therefore, the electronic device trains the initial processing model based on the third sample image feature and the target sample image feature, to obtain the task processing model, making an image feature outputted by the task processing model close to the target sample image feature.

In some embodiments, the electronic device determines a loss parameter based on the third sample image feature and the target sample image feature, and trains the initial processing model based on the loss parameter, to obtain the task processing model. The loss parameter may be a cross entropy loss, a mean square error loss, or the like. This is not limited in the embodiments of this application.

According to the method provided in this embodiment of this application, when an image that needs to be processed in the target task does not match the target resolution corresponding to the image encoding and decoding model, the image is divided into a plurality of sub-images whose resolutions are equal to the target resolution, so that the sub-images are directly encoded by using the image encoding and decoding model. In addition, location features of the sub-images are further fused with image features of the sub-images, to retain location information of each sub-image in the complete image. Further, the image feature of each sub-image is processed by using the initial processing model, and model training is performed based on a processed image feature and a to-be-generated image feature (also referred to as a “target image feature”), to obtain the task processing model for processing the target task. In this way, the image is divided and the location information is retained, so that the task processing model is applicable to an image of any resolution, improving adaptability of a data processing method.

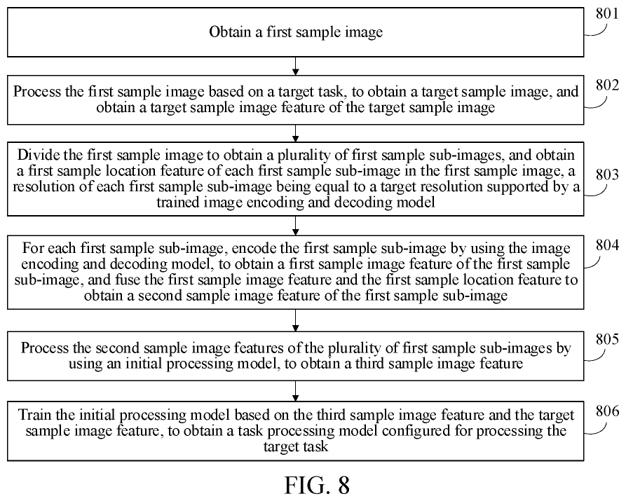

FIG. 9 is a flowchart of a training method for a task processing model according to an embodiment of this application. This embodiment of this application is executed by an electronic device. The electronic device may be the terminal 101 or the server 102 in FIG. 1. Referring to FIG. 9, the method includes the following operations.

901: Obtain a first sample image and first sample non-image data, both the first sample image and the first sample non-image data being to-be-processed data in a target task.

The target task is a multi-modal task. The multi-modal task is a task for processing a plurality of types of data. The first sample non-image data is other data except an image. For example, the first sample non-image data may be a text, a video, or audio. This is not limited in the embodiments of this application.

A process of operation 901 is similar to the process of operation 401. Details are not described herein again.

902: Process the first sample image based on the target task, to obtain a target sample image, and obtain a target sample image feature of the target sample image.

The target sample image is a result of processing the first sample image based on the target task.

903: Divide the first sample image to obtain a plurality of first sample sub-images, and obtain a first sample location feature of each first sample sub-image in the first sample image, a resolution of each first sample sub-image being equal to a target resolution supported by a trained image encoding and decoding model.

904: For each first sample sub-image, encode the first sample sub-image by using the image encoding and decoding model, to obtain a first sample image feature of the first sample sub-image, and fuse the first sample image feature and the first sample location feature to obtain a second sample image feature of the first sample sub-image.

Processes of operation 903 and operation 904 are the same as the processes of operation 803 and operation 804. Details are not described herein again.

905: Perform feature extraction on the first sample non-image data to obtain a first sample data feature.

A process of operation 905 is similar to the process of operation 404. Details are not described herein again.

906: Process the second sample image features of the plurality of first sample sub-images and the first sample data feature of the first sample non-image data by using an initial processing model, to obtain a third sample image feature and a second sample data feature.

In some embodiments, when predicting the second sample data feature by using the initial processing model, the electronic device predicts the second sample data feature in a manner of predicting a subsequent feature based on a preceding feature. For example, the first sample non-image data is a first sample text, the first sample data feature is a first sample text feature, and the first sample text feature includes a first sample text feature of each sample word in the first sample text. The electronic device sequentially inputs the second sample image features of the plurality of first sample sub-images and the first sample text features of the plurality of sample words into the initial processing model. The initial processing model determines a second sample text feature of a 1^{st} to-be-predicted word based on a feature preceding the first sample text feature of the 1^{st} sample word, determines a second sample text feature of a 2^{nd} to-be-predicted word based on a feature preceding the first sample text feature of the 2^{nd} sample word, and so on, until second sample text features of all to-be-predicted words are outputted, forming the second sample data feature. If the initial processing model is appropriately accurate, second sample text features of a plurality of to-be-predicted words predicted by the initial processing model need to be close to the first sample text features of the plurality of sample words.

907: Train the initial processing model based on the third sample image feature, the target sample image feature, the second sample data feature, and the first sample data feature, to obtain a task processing model.

In this embodiment of this application, a target of the initial processing model is to generate the target sample image feature and the first sample data feature. In other words, a higher similarity between the third sample image feature generated by the initial processing model and the target sample image feature indicates a higher similarity between the second sample data feature generated by the initial processing model and the first sample data feature and higher accuracy of the model.

Therefore, the electronic device trains the initial processing model based on the third sample image feature, the target sample image feature, the second sample data feature, and the first sample data feature, to obtain the task processing model, making an image feature generated by the task processing model close to the target sample image feature and a data feature generated by the task processing model close to the first sample data feature.

In some embodiments, the electronic device determines a first loss parameter based on the third sample image feature and the target sample image feature, determines a second loss parameter based on the second sample data feature and the first sample data feature, fuses the first loss parameter and the second loss parameter to obtain a fused loss parameter, and trains the initial processing model based on the fused loss parameter, to obtain the task processing model. The foregoing loss parameter may be a cross entropy loss, a mean square error loss, or the like. This is not limited in the embodiments of this application.

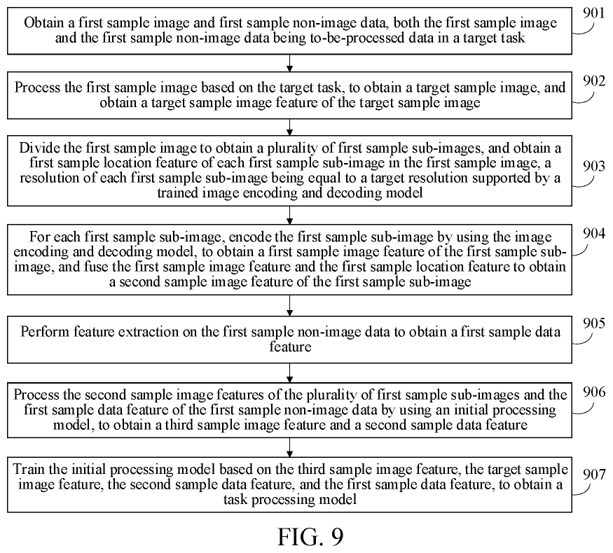

FIG. 10 is a flowchart of another training method for a task processing model according to an embodiment of this application. As shown in FIG. 10, to-be-processed data in a target task includes a first sample image and a first sample text. The first sample image is divided and scaled to obtain an image sequence 1001. The image sequence 1001 includes sub-images 10012 to 10015 obtained through division and an image 10011 obtained through scaling down. The first sample text is “Lucky likes playing in the park.” The images 10011 to 10015 in the image sequence 1001 are encoded by using an image encoding network (not shown) of an image encoding and decoding model, to obtain an image feature 1002. The first text is encoded to obtain a text feature 1003. An electronic device further randomly generates an image feature 1004, adds an image start marker “IMG” in front of each of the image feature 1002 and the image feature 1004, adds an image end marker “/IMG” behind each of the image feature 1002 and the image feature 1004, and adds a start marker “BOI” in front of the inputted features that are considered as a whole.

As shown in FIG. 10, the electronic device inputs the foregoing features and markers into an initial processing model, and the initial processing model outputs a predicted image feature 1005 and a predicted text feature 1006. The electronic device further obtains an image feature 1007 of a target sample image. The electronic device determines a first loss parameter based on the image feature 1005 and the image feature 1007, determines a second loss parameter based on the text feature 1006 and the text feature 1003, and trains the initial processing model based on the first loss parameter and the second loss parameter, to obtain a task processing model.

FIG. 11 is a flowchart of a training method for an image encoding and decoding model according to an embodiment of this application. This embodiment of this application is executed by an electronic device. The electronic device may be the terminal 101 or the server 102 in FIG. 1. Referring to FIG. 11, the method includes the following operations.

1101: Obtain a second sample image.

The second sample image may be an image of any field, any type, or any resolution. The second sample image is not limited in the embodiments of this application.

1102: Divide the second sample image to obtain a plurality of second sample sub-images, and obtain a third sample location feature of each second sample sub-image in the second sample image, a resolution of each second sample sub-image being equal to a target resolution.

1103: For each second sample sub-image, encode the second sample sub-image by using an initial image encoding and decoding model, to obtain a fourth sample image feature of the second sample sub-image, and fuse the fourth sample image feature and the third sample location feature to obtain a fifth sample image feature of the second sample sub-image.

In some embodiments, that the electronic device obtains a third sample location feature of each second sample sub-image in the second sample image includes:
for any second sample sub-image,
determining coordinate information of the second sample sub-image in the second sample image; and
mapping the coordinate information based on a preset mapping parameter, to obtain the third sample location feature of the second sample sub-image.

Subsequently, in operation 1105, the initial image encoding and decoding model and the preset mapping parameter are trained based on a difference between a third sample image and the second sample image.

The initial image encoding and decoding model includes an initial image encoding network and an initial image decoding network. The initial image encoding network may be an initialized VAI or ViT, and the initial image decoding network includes a plurality of initialized cross-attention layers.

The preset mapping parameter is initial values of a left-side mapping parameter, a right-side mapping parameter, an upper-side mapping parameter, and a lower-side mapping parameter.

Processes of operation 1102 and operation 1103 are similar to the processes of operation 302 and operation 303. Details are not described herein again.

1104: Decode the fifth sample image features of the plurality of second sample sub-images by using the initial image encoding and decoding model, to obtain the third sample image.

In some embodiments, the electronic device obtains a reference sample image, a part of content of the reference sample image being the same as that of the second sample image, that is, the reference sample image and the second sample image having same content and different content; performs feature conversion on the reference sample image by using the initial image encoding and decoding model, to obtain a sample query feature; performs feature conversion on the fifth sample image features of the plurality of second sample sub-images by using the initial image encoding and decoding model, to obtain a sample key feature and a sample value feature; fuses the sample query feature, the sample key feature, and the sample value feature, to obtain a sample fused feature; and decodes the sample fused feature by using the initial image encoding and decoding model, to obtain the third sample image.

For example, the second sample image includes two dogs, and the reference sample image is an image obtained by adding a third dog to the second sample image. Alternatively, the second sample image includes three persons, and the reference sample image is an image obtained by adding a bundle of flowers to the second sample image.

1105: Train the initial image encoding and decoding model based on the third sample image and the second sample image, to obtain a trained image encoding and decoding model.

In this embodiment of this application, a training target of the image encoding and decoding model is to reconstruct the second sample image. In other words, a higher similarity between the third sample image generated by the image encoding and decoding model and the second sample image indicates higher accuracy of the model. Therefore, the electronic device trains the initial image encoding and decoding model based on the third sample image and the second sample image, making an image generated by the trained image encoding and decoding model close to the second sample image.

In some embodiments, the electronic device determines a loss parameter based on the third sample image and the second sample image, and trains the initial image encoding and decoding model based on the loss parameter, to obtain the trained image encoding and decoding model. The loss parameter may be a cross entropy loss, a mean square error loss, or the like. This is not limited in the embodiments of this application.

A training process for the image encoding and decoding model may be divided into two phases. In the first phase, during decoding, an image feature is directly decoded by using the initial image encoding and decoding model without introducing a reference image. In the second stage, during decoding, an image feature is decoded based on a reference image by using the initial image encoding and decoding model.

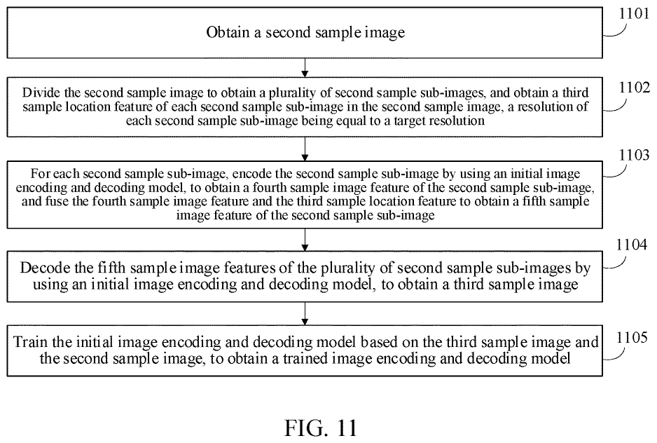

FIG. 12 is a schematic diagram showing a training method for an image encoding and decoding model according to an embodiment of this application. As shown in FIG. 12, an initial image encoding and decoding model includes an image encoding network 1210 and an image decoding network 1220.

In a first phase, an original image A is respectively encoded and decoded by using the image encoding network 1210 and the image decoding network 1220, to finally obtain a reconstructed image B. Then, the image encoding network 1210 and the image decoding network 1220 are trained based on a difference between the reconstructed image B and the original image A. In this case, the difference is mainly a difference in semantic consistency. In addition to an image feature, noise is further inputted into the image decoding network 1220.

In a second phase, an original image C1 is respectively encoded and decoded by using the image encoding network 1210 and the image decoding network 1220, and a reference image C2 is introduced during decoding, to finally obtain a reconstructed image D. Then, the image encoding network 1210 and the image decoding network 1220 are trained based on a difference between the reconstructed image D and the original image C1. In this case, the difference is mainly a difference in fine-grained semantic consistency. In addition to an image feature, the reference image C2 and noise are further inputted into the image decoding network 1220.

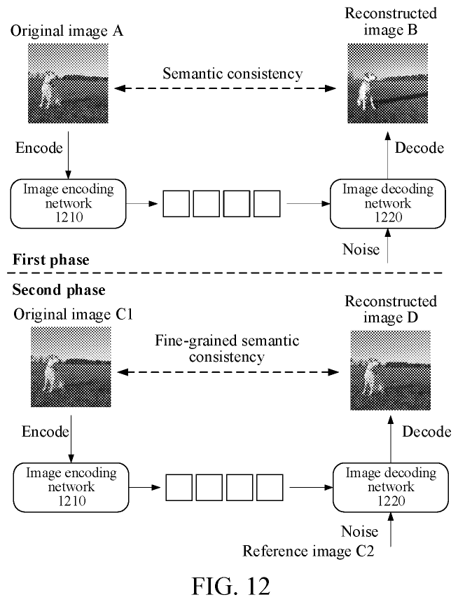

FIG. 13 is a comparison diagram showing reconstruction results of an image encoding and decoding model according to an embodiment of this application. As shown in FIG. 13, an original image A1 is reconstructed by using a related technology, to obtain a reconstructed image B1. When the method of this embodiment of this application is used and no reference image is introduced, the original image A1 is reconstructed to obtain a reconstructed image B2. When the method of this embodiment of this application is used and a reference image A2 is introduced, the original image A1 is reconstructed to obtain a reconstructed image B3. As can be seen from FIG. 13, the reconstructed image B3 obtained when the method of this embodiment of this application is used and the reference image is introduced is closer to the original image A1, and has a better reconstruction effect.

In the embodiments of FIG. 8 and FIG. 9, the task processing model is obtained through training based on the initial processing model, to obtain a task processing model specifically configured for executing a specific target task. The initial processing model may be a model obtained through pre-training. The pre-training process for the initial processing model is similar to the training process for the task processing model, and a difference lies in that a training sample used in the training process for the task processing model is data in the target task, while a training sample used in the pre-training process for the initial processing model may be data in any scenario. For the pre-training process for the initial processing model, refer to the following embodiment shown in FIG. 14.

FIG. 14 is a flowchart of a pre-training method for an initial processing model according to an embodiment of this application. This embodiment of this application is executed by an electronic device. The electronic device may be the terminal 101 or the server 102 in FIG. 1. Referring to FIG. 14, the method includes the following operations.

1401: Obtain a fourth sample image, and obtain a sample image feature of a fifth sample image, the fifth sample image being an image associated with the fourth sample image in content.

The fifth sample image is an associated image of the fourth sample image. For example, the fourth sample image and the fifth sample image belong to a same piece of image-text data, and the fifth sample image is a subsequent image of the fourth sample image. Alternatively, a similarity between the fifth sample image and the fourth sample image reaches a preset threshold. This is not limited in the embodiments of this application.

A process in which the electronic device obtains the sample image feature of the fifth sample image is the same as the process of obtaining the target sample image feature of the target sample image in the foregoing operation. Details are not described herein again.

1402: Divide the fourth sample image to obtain a plurality of fourth sample sub-images, and obtain a fourth sample location feature of each fourth sample sub-image in the fourth sample image, a resolution of each fourth sample sub-image being equal to a target resolution.

1403: For each fourth sample sub-image, encode the fourth sample sub-image by using an image encoding and decoding model, to obtain a sixth sample image feature of the fourth sample sub-image, and fuse the sixth sample image feature and the fourth sample location feature to obtain a seventh sample image feature of the fourth sample sub-image.

1404: Process the seventh sample image features of the plurality of fourth sample sub-images by using an initial processing model that has been initialized, to obtain an eighth sample image feature.

1405: Pre-train the initial processing model based on the eighth sample image feature and the sample image feature of the fifth sample image.

Processes of operation 1402 to operation 1405 are the same as the processes of operation 803 to operation 806. Details are not described herein again.

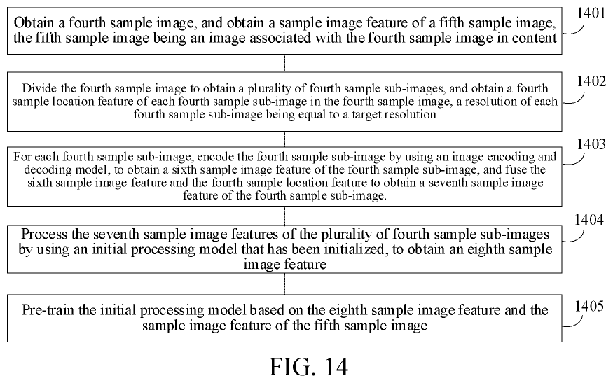

FIG. 15 is a comparison diagram showing data processing results according to an embodiment of this application. The target task is processing, when a text and an image are provided, the image based on a requirement described in the text. FIG. 15 shows images generated by processing texts and images in different target tasks by using related technologies 1 to 4 and by using the method in the embodiments of this application. As can be seen from FIG. 15, compared with the related technologies, an image generated by using the method in the embodiments of this application better meets the processing requirement described in the text in the target task. According to the embodiments of this application, data effects can be improved while the adaptability of the data processing method is improved.

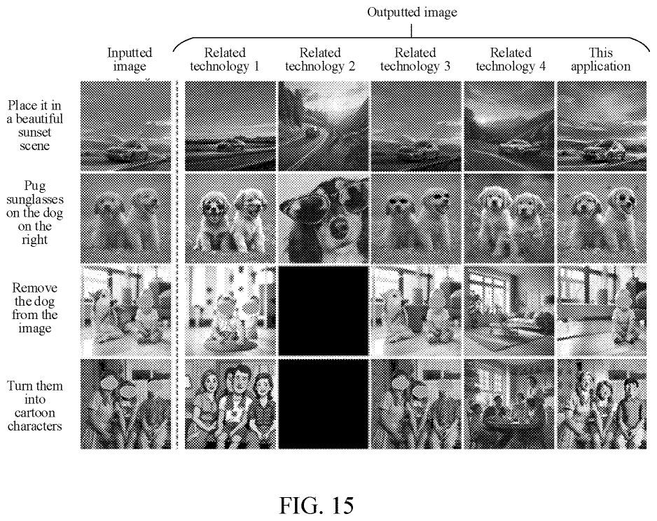

FIG. 16 is a schematic diagram showing a structure of a data processing apparatus according to an embodiment of this application. Referring to FIG. 16, the data processing apparatus 1600 includes:
an obtaining module 1601, configured to obtain a to-be-processed first image in a target task;
an image processing module 1602, configured to divide the first image to obtain a plurality of sub-images, and obtain a first location feature of each sub-image in the first image, a resolution of each sub-image being equal to a target resolution supported by a trained image encoding and decoding model;
an encoding module 1603, configured to: for each sub-image, encode the sub-image by using the image encoding and decoding model, to obtain a first image feature of the sub-image, and fuse the first image feature and the first location feature to obtain a second image feature of the sub-image;
a feature processing module 1604, configured to process the second image features of the plurality of sub-images by using a trained task processing model, to obtain a third image feature; and
a decoding module 1605, configured to decode the third image feature by using the image encoding and decoding model, to obtain a second image.

In some embodiments, referring to FIG. 16, the image processing module 1602 is configured to:
determine a plurality of division policies, each of the division policies including a first division quantity, a second division quantity, and a division ratio, the first division quantity being a division quantity of an image in a length direction, the second division quantity being a division quantity of the image in a width direction, and the division ratio being a ratio of the first division quantity to the second division quantity;
determine a target division policy from the plurality of division policies based on an aspect ratio of the first image, a division ratio in the target division policy being closest to the aspect ratio; and
divide the first image based on the target division policy and the target resolution, to obtain the plurality of sub-images.

In some embodiments, referring to FIG. 16, the image processing module 1602 is configured to:
generate a target size based on the target division policy and the target resolution;
upsample the first image based on the target size, to obtain a first intermediate image; and
divide the first intermediate image according to the target division policy, to obtain the plurality of sub-images.

In some embodiments, referring to FIG. 16, the image processing module 1602 is configured to:
for any sub-image,
determine coordinate information of the sub-image in the first image; and
map the coordinate information based on a mapping parameter, to obtain the first location feature of the sub-image, the mapping parameter being obtained through training.

In some embodiments, referring to FIG. 16, the image encoding and decoding model includes an image encoding network. The image processing module 1602 is further configured to scale the first image down to a second intermediate image, a resolution of the second intermediate image being equal to the target resolution.

The encoding module 1603 is further configured to encode the second intermediate image by using the image encoding network, to obtain an image feature of the second intermediate image.

The feature processing module 1604 is configured to process the second image features of the plurality of sub-images and the image feature of the second intermediate image by using the task processing model, to obtain the third image feature.

In some embodiments, referring to FIG. 16, the image encoding and decoding model includes the image decoding network. The decoding module 1606 is configured to:
perform feature conversion on the first image by using the image decoding network, to obtain a query feature;
perform feature conversion on the third image feature by using the image decoding network, to obtain a key feature and a value feature;
fuse the query feature, the key feature, and the value feature to obtain a fused feature; and
decode the fused feature by using the image decoding network, to obtain the second image.

In some embodiments, referring to FIG. 16, the target task is a multi-modal task, and to-be-processed data in the multi-modal task further includes first non-image data.

The feature processing module 1604 is configured to process the second image features of the plurality of sub-images and a first data feature of the first non-image data by using the task processing model, to obtain the third image feature and a second data feature.

In some embodiments, referring to FIG. 16, the decoding module 1606 is further configured to decode the second data feature to obtain second non-image data.

In some embodiments, referring to FIG. 16, the first non-image data is a text, and the text includes coordinate information of an object in the first image. The feature processing module 1604 is configured to:
convert the coordinate information into a second location feature, and fuse the first data feature and the second location feature to obtain a third data feature; and
process the second image features of the plurality of sub-images and the third data feature by using the task processing model, to obtain the third image feature and the second data feature.

The data processing apparatus provided in the foregoing embodiment is described only using division into the foregoing functional modules as an example. In an actual application, the foregoing functions may be allocated to and completed by different functional modules as required. In other words, an internal structure of the data processing apparatus is divided into different functional modules to complete all or a part of the functions described above. In addition, the data processing apparatus provided in the foregoing embodiment falls within a same concept as the data processing method embodiment. For details of a specific implementation process of the apparatus, refer to the method embodiment. Details are not described herein again.

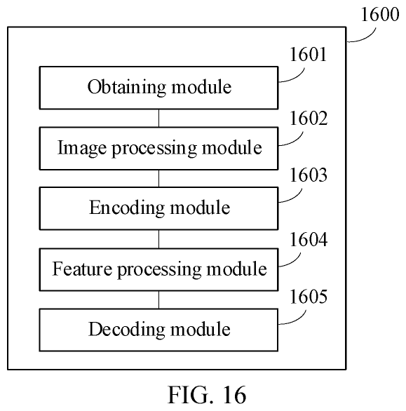

FIG. 17 is a schematic diagram showing a structure of a model training apparatus according to an embodiment of this application. Referring to FIG. 17, the model training apparatus 1700 includes:
an obtaining module 1701, configured to obtain a first sample image, process the first sample image based on a target task, to obtain a target sample image, and obtain a target sample image feature of the target sample image;
an image processing module 1702, configured to divide the first sample image to obtain a plurality of first sample sub-images, and obtain a first sample location feature of each first sample sub-image in the first sample image, a resolution of each first sample sub-image being equal to a target resolution supported by a trained image encoding and decoding model;
an encoding module 1703, configured to: for each first sample sub-image, encode the first sample sub-image by using the image encoding and decoding model, to obtain a first sample image feature of the first sample sub-image, and fuse the first sample image feature and the first sample location feature to obtain a second sample image feature of the first sample sub-image;
a feature processing module 1704, configured to process the second sample image features of the plurality of first sample sub-images by using an initial processing model, to obtain a third sample image feature; and
a first training module 1705, configured to train the initial processing model based on the third sample image feature and the target sample image feature, to obtain a task processing model configured for processing the target task.

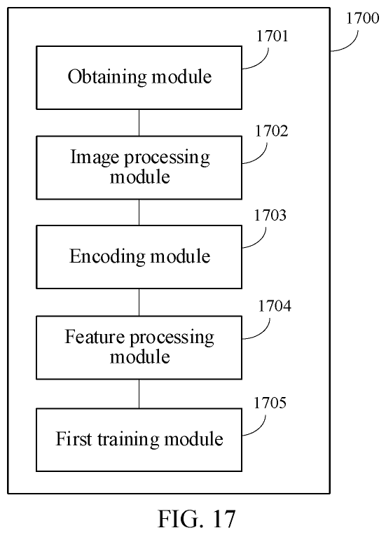

In some embodiments, referring to FIG. 18, the obtaining module 1701 of the model training apparatus 1800 is configured to:
divide the target sample image to obtain a plurality of target sub-images, and obtain a second sample location feature of each target sub-image in the target sample image, a resolution of each target sub-image being equal to a target resolution; and
for each target sub-image,
encode the target sub-image by using an image encoding and decoding model, to obtain an image feature of the target sub-image; and
fuse the image feature and the second sample location feature of the target sub-image to obtain the target sample image feature of the target sub-image.

In some embodiments, referring to FIG. 18,
the obtaining module 1701 is further configured to obtain a second sample image.

The image processing module 1702 is further configured to divide the second sample image to obtain a plurality of second sample sub-images, and obtain a third sample location feature of each second sample sub-image in the second sample image, a resolution of each second sample sub-image being equal to the target resolution.

The encoding module 1703 is further configured to: for each second sample sub-image, encode the second sample sub-image by using an initial image encoding and decoding model, to obtain a fourth sample image feature of the second sample sub-image, and fuse the fourth sample image feature and the third sample location feature to obtain a fifth sample image feature of the second sample sub-image.

The model training apparatus 1800 further includes:
a decoding module 1706, configured to decode the fifth sample image features of the plurality of second sample sub-images by using the initial image encoding and decoding model, to obtain a third sample image; and
a second training module 1707, configured to train the initial image encoding and decoding model based on the third sample image and the second sample image, to obtain the trained image encoding and decoding model.

In some embodiments, referring to FIG. 18, the decoding module 1706 is configured to:
obtain a reference sample image, a part of content of the reference sample image being the same as that of the second sample image;
perform feature conversion on the reference sample image by using the initial image encoding and decoding model, to obtain a sample query feature;
perform feature conversion on the fifth sample image features of the plurality of second sample sub-images by using the initial image encoding and decoding model, to obtain a sample key feature and a sample value feature;
fuse the sample query feature, the sample key feature, and the sample value feature to obtain a sample fused feature; and
decode the sample fused feature by using the initial image encoding and decoding model, to obtain the third sample image.

In some embodiments, referring to FIG. 18, the obtaining module 1701 is configured to:
for any second sample sub-image,
determine coordinate information of the second sample sub-image in the second sample image; and
map the coordinate information based on a preset mapping parameter, to obtain the third sample location feature of the second sample sub-image.

The second training module 1707 is configured to:
train the initial image encoding and decoding model and the preset mapping parameter based on a difference between the third sample image and the second sample image.

In some embodiments, referring to FIG. 18, the initial processing module is obtained through pre-training. The obtaining module 1701 is further configured to obtain a fourth sample image, and obtain a sample image feature of a fifth sample image, the fifth sample image being an image associated with the fourth sample image in content.

The image processing module 1702 is further configured to divide the fourth sample image to obtain a plurality of fourth sample sub-images, and obtain a fourth sample location feature of each fourth sample sub-image in the fourth sample image, a resolution of each fourth sample sub-image being equal to the target resolution.

The encoding module 1703 is further configured to: for each fourth sample sub-image, encode the fourth sample sub-image by using the image encoding and decoding model, to obtain a sixth sample image feature of the fourth sample sub-image, and fuse the sixth sample image feature and the fourth sample location feature to obtain a seventh sample image feature of the fourth sample sub-image.

The feature processing module 1704 is further configured to process the seventh sample image features of the plurality of fourth sample sub-images by using an initial processing model that has been initialized, to obtain an eighth sample image feature.

The model training apparatus 1800 further includes:
a third training module 1708, configured to pre-train the initial processing model based on the eighth sample image feature and the sample image feature of the fifth sample image.

In some embodiments, referring to FIG. 18, the target task is a multi-modal task, and to-be-processed data in the multi-modal task includes the first sample image and first sample non-image data. The feature processing module 1704 is configured to:
process the second sample image features of the plurality of first sample sub-images and a first sample data feature of the first sample non-image data by using the initial processing model, to obtain the third sample image feature and a second sample data feature.

The first training module 1705 is configured to:
train the initial processing model based on the third sample image feature, the target sample image feature, the second sample data feature, and the first sample data feature, to obtain the task processing model.

The model training apparatus provided in the foregoing embodiment is described only using division into the foregoing functional modules as an example. In an actual application, the foregoing functions may be allocated to and completed by different functional modules as required. In other words, an internal structure of the data processing apparatus is divided into different functional modules to complete all or a part of the functions described above. In addition, the model training apparatus provided in the foregoing embodiment falls within a same concept as the model training method embodiment. For details of a specific implementation process of the apparatus, refer to the method embodiment. Details are not described herein again.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

An embodiment of this application further provides an electronic device. The electronic device includes a processor and a memory. The memory has at least one computer program stored therein. The at least one computer program is loaded and executed by the processor, to implement the operations performed in the data processing method in the foregoing embodiment.

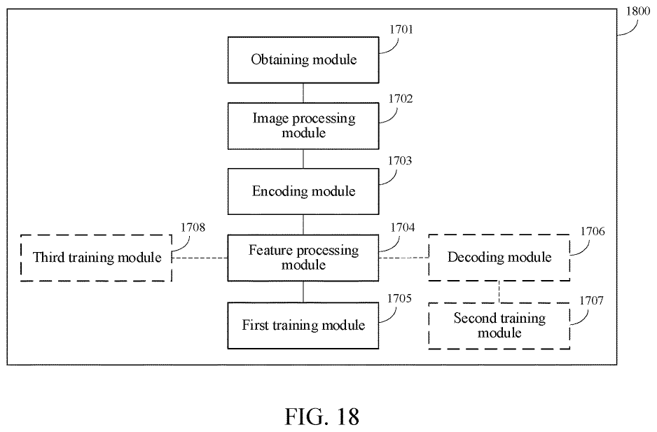

In some embodiments, the electronic device is provided as a terminal. FIG. 19 is a schematic diagram showing a structure of a terminal 1900 according to an exemplary embodiment of this application.

The terminal device 1900 includes a processor 1901 and a memory 1902.

The processor 1901 may include one or more processing cores, such as a four-core processor or an eight-core processor. The processor 1901 may be implemented in at least one hardware form of a digital signal processor (DSP), a field programmable gate array (FPGA), and a programmable logic array (PLA). The processor 1901 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1901 may be integrated with a graphics processing unit (GPU), and the GPU is configured to render and draw content that needs to be displayed on a display screen. In some embodiments, the processor 1901 may further include an artificial intelligence (AI) processor, and the AI processor is configured to process computing operations related to machine learning.

The memory 1902 may include one or more computer-readable storage media. The computer-readable storage medium may be non-transitory. The memory 1902 may further include a high-speed random access memory and a non-volatile memory, for example, one or more disk storage devices and flash storage devices. In some embodiments, the non-transitory computer-readable storage media in the memory 1902 are configured to store at least one computer program. The at least one computer program is configured to be executed by the processor 1901, to implement the data processing method or the model training method provided in the method embodiments of this application.

In some embodiments, the terminal device 1900 may further include a peripheral device interface 1903 and at least one peripheral device. The processor 1901, the memory 1902, and the peripheral device interface 1903 may be connected to each other through a bus or a signal cable. Each peripheral device may be connected to the peripheral device interface 1903 through a bus, a signal cable, or a circuit board. In some embodiments, the peripheral device includes at least one of a radio frequency circuit 1904, a display screen 1905, a camera component 1906, an audio circuit 1907, or a power supply 1908.

The peripheral device interface 1903 may be configured to connect at least one peripheral device related to input/output (I/O) to the processor 1901 and the memory 1902. In some embodiments, the processor 1901, the memory 1902, and the peripheral device interface 1903 are integrated on a same chip or circuit board. In some other embodiments, any one or two of the processor 1901, the memory 1902, and the peripheral device interface 1903 may be implemented on a single chip or circuit board. This is not limited in this embodiment.

The radio frequency circuit 1904 is configured to receive and transmit an RF signal, which is also referred to as an electromagnetic signal. The radio frequency circuit 1904 communicates with a communication network and another communication device by using the electromagnetic signal. The radio frequency circuit 1904 converts an electric signal into an electromagnetic signal for transmission, or converts a received electromagnetic signal into an electric signal. In some embodiments, the radio frequency circuit 1904 includes an antenna system, an RF transceiver, one or more amplifiers, a tuner, an oscillator, a digital signal processor, a codec chipset, a subscriber identity module card, or the like. The radio frequency circuit 1904 may communicate with another device by using at least one wireless communication protocol. The wireless communication protocol includes but is not limited to a metropolitan area network, generations of mobile communication networks (2^{nd} generation (2G), 3^{rd} generation (3G), 4^{th} generation (4G), and 5^{th} generation (5G)), a wireless local area network, and/or a wireless fidelity (Wi-Fi) network. In some embodiments, the radio frequency circuit 1904 may further include a circuit related to near field communication (NFC). This is not limited in this application.

The display screen 1905 is configured to display a user interface (UI). The UI may include a graph, a text, an icon, a video, and any combination thereof. When the display screen 1905 is a touch display screen, the display screen 1905 further has a capability of acquiring a touch signal on or above a surface of the display screen 1905. The touch signal may be inputted into the processor 1901 as a control signal for processing. In this case, the display screen 1905 may be further configured to provide a virtual button and/or a virtual keyboard that are/is also referred to as a soft button and/or a soft keyboard. In some embodiments, there may be one display screen 1905 disposed on a front panel of the terminal 1900. In some other embodiments, there may be at least two display screens 1905 disposed on different surfaces of the terminal 1900 or in a folded design. In some other embodiments, the display screen 1905 may be a flexible display screen, and is disposed on a curved surface or a folded surface of the terminal 1900. The display screen 1905 may be even arranged as a non-rectangular irregular figure, that is, a special-shaped screen. The display screen 1905 may be prepared from a material such as a liquid crystal display (LCD) or an organic light-emitting diode (OLED).

The camera component 1906 is configured to acquire images or videos. In some embodiments, the camera component 1906 includes a front camera and a rear camera. The front camera is disposed on the front panel of the terminal 1900, and the rear camera is disposed on a back of the terminal 1900. In some embodiments, there are at least two rear cameras each of which is any one of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1906 may further include a flash. The flash may be a single color temperature flash or a double color temperature flash. The double color temperature flash is a combination of a warm light flash and a cold light flash, and may be configured for light compensation under different color temperatures.

The audio circuit 1907 may include a microphone and a speaker. The microphone is configured to acquire sound waves of a user and an environment, convert the sound waves into an electric signal, and input the electric signal into the processor 1901 for processing, or input the electric signal into the radio frequency circuit 1904 for implementing voice communication. For the purpose of stereo acquisition or noise reduction, there may be a plurality of microphones disposed at different parts of the terminal 1900. The microphone may alternatively be an array microphone or an omni-directional capture microphone. The speaker is configured to convert electric signals from the processor 1901 or the radio frequency circuit 1904 into sound waves. The speaker may be a thin-film speaker or a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 1907 may further include a headset jack.

The power supply 1908 is configured to supply power to each component of the terminal 1900. The power supply 1908 may be alternating current, direct current, a primary battery, or a rechargeable battery. When the power supply 1908 includes a rechargeable battery, the rechargeable battery may support wired charging or wireless charging. The rechargeable battery may be further configured to support a fast charge technology.

A person skilled in the art may understand that the structure shown in FIG. 19 constitutes no limitation on the terminal 1900, and the terminal may include more or fewer components than those shown in the figure, or some components may be combined, or a different component deployment may be used.

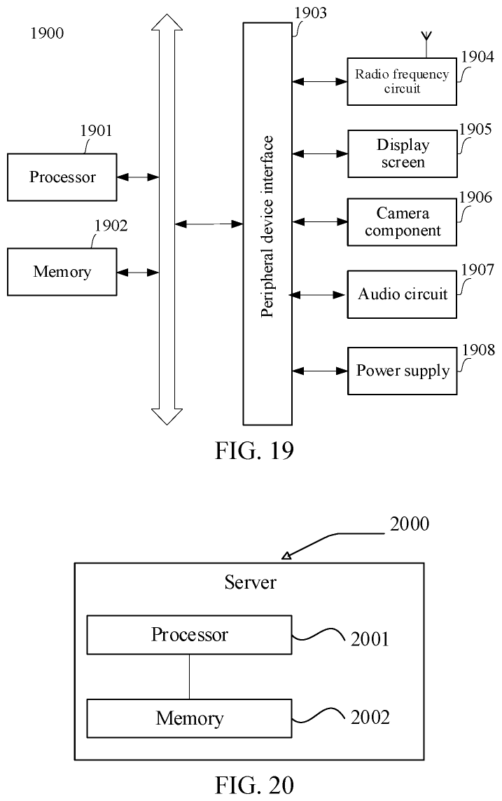

In some embodiments, the electronic device is provided as a server. FIG. 20 is a schematic diagram showing a structure of a server according to an embodiment of this application. The server 2000 may vary considerably depending on configuration or performance, and may include one or more central processing units (CPUs) 2001 and one or more memories 2002. Each memory 2002 has at least one computer program stored therein. The at least one computer program is loaded and executed by the processor 2001, to implement the methods provided in the foregoing method embodiments. Certainly, the server may further have components such as a wired or wireless network interface, a keyboard, and an input/output interface, to perform input and output. The server may further include another component configured to implement a device function. Details are not described herein.

An embodiment of this application further provides a computer-readable storage medium. The computer-readable storage medium has at least one computer program stored therein. The at least one computer program is loaded and executed by a processor, to implement the operations performed in the data processing method or the model training method described in the foregoing embodiments.

An embodiment of this application further provides a computer program product, including a computer program. The computer program is loaded and executed by a processor, to implement the operations performed in the data processing method or the model training method described in the foregoing embodiments.

A person of ordinary skill in the art may understand that all or a part of the operations in the foregoing embodiments may be completed by hardware or by a program instructing related hardware. The program may be stored in a computer-readable storage medium. The storage medium may be a read-only memory, a magnetic disk, an optical disk, or the like.

The above descriptions are merely exemplary embodiments of the embodiments of this application, and are not intended to limit the embodiments of this application. Any modification, equivalent replacement, improvement, or the like made within the spirit and principle of the embodiments of this application falls within the protection scope of this application.

What is claimed is:

1. A data processing method, performed by an electronic device, comprising:
obtaining a first image in a target task;
dividing the first image into a plurality of sub-images each having a resolution equal to a target resolution supported by an image encoding and decoding model;
for each sub-image:
obtaining a location feature of the sub-image in the first image;
encoding the sub-image using the image encoding and decoding model, to obtain a first image feature of the sub-image; and
fusing the first image feature and the location feature to obtain a second image feature of the sub-image;
processing the second image features of the plurality of sub-images using a task processing model, to obtain a third image feature; and
decoding the third image feature using the image encoding and decoding model, to obtain a second image.

2. The method according to claim 1, wherein dividing the first image includes:
determining a plurality of division policies each including a division ratio, the division ratio being a ratio of a division quantity of an image in a length direction to a division quantity of the image in a width direction;
determining a target division policy from the plurality of division policies based on an aspect ratio of the first image, the target division policy being one of the plurality of division policies that has a division ration closest to the aspect ratio; and
dividing the first image based on the target division policy and the target resolution, to obtain the plurality of sub-images.

3. The method according to claim 2, wherein dividing the first image based on the target division policy and the target resolution includes:
generating a target size based on the target division policy and the target resolution;
upsampling the first image based on the target size, to obtain an intermediate image; and
dividing the intermediate image according to the target division policy, to obtain the plurality of sub-images.

4. The method according to claim 1, wherein obtaining the location feature of the sub-image includes:
determining coordinate information of the sub-image in the first image; and
mapping the coordinate information based on a mapping parameter, to obtain the location feature of the sub-image, the mapping parameter being obtained through training.

5. The method according to claim 1, further comprising:
scaling the first image down to an intermediate image having a resolution equal to the target resolution; and
encoding the intermediate image using an image encoding network in the image encoding and decoding model, to obtain an image feature of the intermediate image;
wherein processing the second image features of the plurality of sub-images includes:
processing the second image features of the plurality of sub-images and the image feature of the intermediate image using the task processing model, to obtain the third image feature.

6. The method according to claim 1, wherein:
the image encoding and decoding model include an image decoding network; and
decoding the third image feature includes:
performing feature conversion on the first image using the image decoding network, to obtain a query feature;
performing feature conversion on the third image feature using the image decoding network, to obtain a key feature and a value feature;
fusing the query feature, the key feature, and the value feature to obtain a fused feature; and
decoding the fused feature using the image decoding network, to obtain the second image.

7. The method according to claim 1, wherein:
the target task is a multi-modal task, and target data in the multi-modal task includes non-image data; and
processing the second image features includes:
processing the second image features of the plurality of sub-images and a first data feature of the non-image data using the task processing model, to obtain the third image feature and a second data feature.

8. The method according to claim 7,
wherein the non-image data is first non-image data; and
the method further comprising:
decoding the second data feature to obtain second non-image data.

9. The method according to claim 7, wherein:
the location feature is a first location feature;
the non-image data includes a text, and the text includes coordinate information of an object in the first image; and
processing the second image features and the first data feature includes:
converting the coordinate information into a second location feature, and fusing the first data feature and the second location feature to obtain a third data feature; and
processing the second image features of the plurality of sub-images and the third data feature using the task processing model, to obtain the third image feature and the second data feature.

10. A non-transitory computer-readable storage medium storing at least one computer program that, when executed by a processor, causes an electronic device including the processor to perform the method according to claim 1.

11. An electronic device comprising:
a processor; and
a memory storing at least one computer program that, when executed by the processor, causes the electronic device to:
obtain a first image in a target task;
divide the first image into a plurality of sub-images each having a resolution equal to a target resolution supported by an image encoding and decoding model;
for each sub-image:
obtain a location feature of the sub-image in the first image;
encode the sub-image using the image encoding and decoding model, to obtain a first image feature of the sub-image; and
fuse the first image feature and the location feature to obtain a second image feature of the sub-image;
process the second image features of the plurality of sub-images using a task processing model, to obtain a third image feature; and
decode the third image feature using the image encoding and decoding model, to obtain a second image.

12. A model training method, performed by an electronic device, comprising:
obtaining a sample image;
processing the sample image based on a target task, to obtain a target sample image, and obtaining a target sample image feature of the target sample image;
dividing the sample image into a plurality of sample sub-images each having a resolution equal to a target resolution supported by an image encoding and decoding model;
for each sample sub-image:
obtaining a sample location feature of the sample sub-image in sample image;
encoding the sample sub-image using the image encoding and decoding model, to obtain a first sample image feature of the sample sub-image; and
fusing the first sample image feature and the sample location feature to obtain a second sample image feature of the sample sub-image;
processing the second sample image features of the plurality of sample sub-images using an initial processing model, to obtain a third sample image feature; and
training the initial processing model based on the third sample image feature and the target sample image feature, to obtain a task processing model configured for processing the target task.

13. The method according to claim 12, wherein:
the sample location feature is a first sample location feature; and
obtaining the target sample image feature includes:
dividing the target sample image into a plurality of target sub-images each having a resolution equal to the target resolution; and
for each target sub-image:
obtaining a second sample location feature of the target sub-image in the target sample image;
encoding the target sub-image using the image encoding and decoding model, to obtain an image feature of the target sub-image; and
fusing the image feature and the second sample location feature of the target sub-image to obtain a target sample image feature of the target sub-image.

14. The method according to claim 12, wherein:
the sample image is a first sample image, the plurality of sample sub-images are a plurality of first sample sub-images, and the sample location feature is a first sample location feature; and
a training process for the image encoding and decoding model includes:
obtaining a second sample image;
dividing the second sample image into a plurality of second sample sub-images each having a resolution equal to the target resolution;
for each second sample sub-image:
obtaining a second sample location feature of the second sample sub-image in the second sample image;
encoding the second sample sub-image using an initial image encoding and decoding model, to obtain a fourth sample image feature of the second sample sub-image; and
fusing the fourth sample image feature and the second sample location feature to obtain a fifth sample image feature of the second sample sub-image;
decoding the fifth sample image features of the plurality of second sample sub-images using the initial image encoding and decoding model, to obtain a third sample image; and
training the initial image encoding and decoding model based on the third sample image and the second sample image, to obtain the image encoding and decoding model.

15. The method according to claim 14, wherein decoding the fifth sample image features includes:
obtaining a reference sample image, a content of the reference sample image being at least partially same as a content of the second sample image;
performing feature conversion on the reference sample image using the initial image encoding and decoding model, to obtain a sample query feature;
performing feature conversion on the fifth sample image features using the initial image encoding and decoding model, to obtain a sample key feature and a sample value feature;
fusing the sample query feature, the sample key feature, and the sample value feature to obtain a sample fused feature; and
decoding the sample fused feature using the initial image encoding and decoding model, to obtain the third sample image.

16. The method according to claim 14, wherein:
obtaining the second sample location feature of the second sample sub-image includes:
determining coordinate information of the second sample sub-image in the second sample image; and
mapping the coordinate information based on a preset mapping parameter, to obtain the second sample location feature of the second sample sub-image; and
training the initial image encoding and decoding model includes:
training the initial image encoding and decoding model and the preset mapping parameter based on a difference between the third sample image and the second sample image.

17. The method according to claim 12, wherein:
the sample image is a first sample image, the plurality of sample sub-images are a plurality of first sample sub-images, and the sample location feature is a first sample location feature; and
the initial processing model is obtained through a pre-training process including:
obtaining a second sample image;
obtaining a sample image feature of a third sample image associated with the second sample image in content;
dividing the second sample image into a plurality of second sample sub-images each having a resolution equal to the target resolution;
for each second sample sub-image:
obtaining a second sample location feature of the second sample sub-image in the second sample image;
encoding the second sample sub-image using the image encoding and decoding model, to obtain a fourth sample image feature of the second sample sub-image; and
fusing the fourth sample image feature and the second sample location feature to obtain a fifth sample image feature of the second sample sub-image;
processing the fifth sample image features of the plurality of second sample sub-images using an initial processing model that has been initialized, to obtain a sixth sample image feature; and
pre-training the initial processing model based on the sixth sample image feature and the sample image feature of the third sample image.

18. The method according to claim 12, wherein:
the target task is a multi-modal task, and target data in the multi-modal task includes the sample image and sample non-image data;
processing the second sample image features includes:
processing the second sample image features of the plurality of sample sub-images and a first sample data feature of the sample non-image data using the initial processing model, to obtain the third sample image feature and a second sample data feature; and
training the initial processing model includes:
training the initial processing model based on the third sample image feature, the target sample image feature, the second sample data feature, and the first sample data feature, to obtain the task processing model.

19. An electronic device comprising:
a processor; and
a memory storing at least one computer program that, when executed by the processor, causes the electronic device to perform the method according to claim 12.

20. A non-transitory computer-readable storage medium storing at least one computer program that, when executed by a processor, causes an electronic device including the processor to perform the method according to claim 12.
